(19) United States
(12) Patent Application Publication
(10) Pub. No.: US 2016/0371438 A1
(43) Pub. Date: Dec. 22, 2016

(54) SYSTEM AND METHOD FOR BIOMETRIC-BASED AUTHENTICATION OF A USER FOR A SECURE EVENT CARRIED OUT VIA A PORTABLE ELECTRONIC DEVICE

(71) Applicant: ProQual-I.T., Inc., Rockville, MD (US)

(72) Inventor: James Martin Annulis, Rockville, MD (US)

(73) Assignee: ProQual-I.T., Inc., Rockville, MD (US)

(21) Appl. No.: 15/187,422

(22) Filed: Jun. 20, 2016

Related U.S. Application Data
(60) Provisional application No. 62/182,166, filed on Jun. 19, 2015.
(60) Provisional application No. 62/187,609, filed on Jul. 1, 2015.
(60) Provisional application No. 62/199,508, filed on Jul. 31, 2015.

(51) Int. Cl. G06F 19/00; G06F 21/62; G06F 21/32

(52) U.S. Cl. CPC G06F 19/322; G06F 21/32; G06F 19/328; G06F 21/6245

(57) ABSTRACT

A biometric-based verification system comprises a first portable device configured to biometrically verify an authorized user, wherein biometric verification comprises capturing via the portable device at least one of a number of biometric attributes of the authorized user; a first database comprising stored biometric data relating to a number of authorized users; and a second database comprising stored data relating protected personal information; wherein the first portable device is configured to confirm that the at least one biometric attribute of the authorized user corresponds with biometric data stored in the first database associated with the authorized user, and wherein upon verification of the authorized user, the portable device is configured to retrieve protected information from the second database. In another embodiment, the system further comprising means of obtaining a personal identifier via the portable electronic device, via scan or QR code.

### CROSS REFERENCE TO RELATED APPLICATIONS

This application claims the benefit of earlier-filed provisional patent application Nos. 62/182,166; 62/187,609; and 62/199,508, filed Jun. 19, 2015; Jul. 1, 2015; and Jul. 31, 2015, respectively, the contents of which are hereby incorporated by reference in their entireties.

### BACKGROUND

The world of healthcare is faced with a serious challenge: giving providers and patients the convenience of mobile access to patient data, yet guarding against unauthorized access to that data. History has proven that username/password-based security is inadequate, yet health IT applications continue to use that method to authenticate users. With the proliferation of those applications through the acceleration of health IT, one could safely predict that there will be several health-related data breaches in the near future, leading to identity theft or worse—such as a hacker covertly updating a patient's data, leading to mistreatment of the patient.

Despite the need for proper security measures, most healthcare applications continue to use traditional methods to protect data: encryption of the data (at rest and in motion); and a username/password combination to gain access to the application's data. The problems with these traditional approaches are well-known: if a hacker gains access to a username and password, they can fraudulently gain access to that user's account. If the hacked user has been granted access to several patients' records (e.g., the hacked user is an office administrator or doctor), the footprint of the data breach can be quite extensive.

### SUMMARY OF THE INVENTION

The present invention disclosed provides a method to authenticate and grant authorized users remote access to sensitive transactions or information that is much safer and more effective than the traditional combination of username and password. Even more beneficial, the invention disclosed herein requires no additional hardware other than a portable electronic device, such as a smartphone or tablet, or other similar hand-held mobile device, configured as described herein.

The solution provided is a portable device configured with a biometric verification process based on physical attributes (face, voice, fingerprint, etc.) that authenticates a user on one or more biometric criteria prior to granting access to sensitive information. The verification process involves an interaction with a mobile device—such as looking at the device to perform facial verification via a camera or voice verification via a microphone. This process can ensure that only authorized individuals gain access to a secure record or account (such as a health record or financial account), or sensitive data (such as personal information), which is a critical requirement for successful healthcare solutions.

The invention provides a biometrics-based verification tool to authenticate users prior to accessing an account, which achieves the following key benefits: sensitive data can only be accessed by authorized individuals (who have been pre-authorized).

Benefits of the biometric-based process provided include the ability of each individual to obtain insight into the authenticity of the other individual.

For example, in a healthcare setting, a patient has assurance that the proper person is providing treatment—guarding against fraud—which is especially important for certain healthcare treatment, such as home healthcare visits (i.e., which are not conducted in a professional office setting, making it more important to give the patient assurance of provider authenticity). Likewise, a provider has assurance that the proper person is being treated—guarding against insurance fraud, in which a person other than the insured patient falsely claims to be the insured patient. Also, insurance companies (who will receive the validation data for each appointment) have assurance that billed services were provided for to the proper patients, and by the proper providers, at the proper time and location. For example, healthcare visits are authenticated by check-in and check-out feature, which also helps detect fraud.

In one embodiment, a computer-implemented system and method for biometric-based management of a secure event carried out on a portable device, comprises: providing a mobile application stored on a machine readable storage medium on the portable device; executing the mobile application on the portable device to verify, based on at least one biometric criteria, a pre-authorized user; and to authorize a secure event to be carried out via the portable device, wherein the secure event is a healthcare-related transaction or a financial transaction.

In one embodiment, a computer-implemented system and method for biometric-based management of a secure event carried out on a portable device, comprises: providing a mobile application stored on a machine readable storage medium on the portable device; executing the mobile application on the portable device to verify, based on at least one biometric criteria, a first authorized user; and to authorize a secure event to be carried out, wherein the secure event is a healthcare transaction including but not limited to: (a) accessing one or more of a patient health record, (b) managing services, prescription medications or treatments provided or subscribed to a patient, and/or (c) updating a patient health record, in any combination thereof using the portable device.

In one embodiment, the system is configured as a healthcare management system, comprising a first portable device configured to biometrically verify a first authorized user, wherein biometrical verification comprises capturing via the first portable device at least one of a number of biometric attributes of the first authorized user; a first database comprising stored biometric data relating to a at least one authorized user; and a second database comprising stored data relating to at least one patient health care record of at least one patient; wherein the first portable device is configured to confirm that the at least one biometric attribute of the first authorized user corresponds with biometric data stored in the first database associated with the first authorized user, and wherein upon verification of the first authorized user, the portable device is configured to retrieve a patient health care record from the second database, and wherein the first database and the second database are stored on at least one remote server, and wherein the first portable device is provided with a communication unit for communicating with the remote server to access the first and/or the second database.

In another embodiment, the first database may be alternatively stored on the portable device, and in addition, the second database may be alternatively stored on the portable device.

In yet another embodiment, the first portable device is configured to perform at least one action related to a patient healthcare record stored in the second database, selected from: (a) accessing one or more of a patient health record, (b) managing services, prescription medications, or treatments provided or subscribed to a patient, and (c) updating a patient health record, in any combination thereof using the first portable device.

In yet another embodiment, the first portable device is configured to identify the patient by receiving at least one of a number of biometric attributes of the patient, and is further configured to confirm that the identified patient is the owner of a patient healthcare record and the first portable device is configured to transmit information to the patient healthcare record to store in the second database.

In one embodiment, the first database and/or the second database comprise stored data including personal identifying information, selected from: government-issued identifying information such as a social security number, SSN, a passport number, a driver's license number, for the first authorized user, wherein the first authorized user has provided information related to identity and/or health history for encrypted storage in one or more of the first database or second database.

In another embodiment, the first database comprises at least one of: a biometric attribute or government-issued identifying information for the first authorized user, wherein the first authorized user has provided at least one biometric attribute including but not limited to: images, fingerprint scans, or voice data, or any other biometric-based attributed suitable for encrypted storage in the first database.

In another embodiment, the second portable device is configured to provide a patient identifier to the first portable device, wherein the patient identifier provides identification information of a patient and the patient identifier provides authorization to retrieve the patient's healthcare record from the second database.

In yet another embodiment, the first portable device is configured to scan a label displayed on the second portable device, and wherein the label provides the patient identifier, allowing the first portable device to retrieve the patient's healthcare record from the second database, wherein the patient identifier is a label or a QR code displayed on the second portable device, and preferably, wherein the label or QR code are displayed on a touch sensitive display of the second portable device when the second portable device detects a predetermined touch on the touch sensitive display, preferably, the predetermined touch is a swipe across the touch sensitive display.

In one embodiment, a portable device comprises a scanner unit configured to capture at least one biometric attribute of a first authorized user; a control unit configured to biometrically verify the first authorized user wherein the control unit controls a communication unit configured to communicate with a first database and confirm that the at least one biometric attribute of the first authorized user corresponds with biometric data stored in the first database associated with the first authorized user, and wherein upon verification of the first authorized user, the portable device is configured to retrieve a patient health care record from a second database wherein the second database comprises stored data relating to a number of patient health care records.

In one embodiment, a method of biometric verification of a user and authorization of a secure event related a client, comprises: capturing via a portable electronic device at least one of a number of biometric attributes of an authorized user; communicating with a first database to verify whether the first captured biometric attribute corresponds to a pre-captured biometric attribute of an authorized user, wherein the first database comprises data corresponding to biometric attributes of the authorized user, and wherein the first database is stored on at least one remote server; retrieving at least a portion of a client record upon verification of the authorized user, wherein the client record comprises a healthcare record stored in a second database, and the second database is stored on at least one remote server.

In another embodiment, the method further comprises updating the client record to include a time/date stamp confirming the occurrence of a secure event, such as a prescription fulfillment event. In yet another embodiment, the timestamp may include GPS coordinates collected from the portable device at the time of time/stamp.

In another embodiment, a non-transitory computer-readable medium having recorded thereon a program that causes a portable device to execute a method comprising capturing via a portable electronic device at least one of a number of biometric attributes of an authorized user; communicating with a first database to verify whether the first captured biometric attribute corresponds to a pre-captured biometric attribute of an authorized user, wherein the first database comprises data corresponding to biometric attributes of the authorized user, and wherein the first database is stored on at least one remote server; retrieving at least a portion of a record upon verification of the authorized user, wherein the record comprises a patient's healthcare record; and updating at least a portion of the record.

### BRIEF DESCRIPTION ON THE DRAWINGS

FIG. 1 shows an overview of a system for biometric-based user authentication, according to one embodiment of the invention.

FIG. 2 shows an overview of a process for biometric-based verification of an authorized user to a protected account, according to one embodiment of the present invention.

FIG. 3 shows an overview of an embodiment of the invention, configured as a mobile application.

FIG. 4 shows an overview of an embodiment of the invention, configured as a mobile application.

FIG. 5 shows an overview of a secure event framework for authorizing user access to a protected account.

FIG. 6 shows an overview of a process for authorizing user access to a protected account.

FIG. 7 shows an overview of a portable electronic device configured with secure event framework logic for biometric-based verification of a pre-authorized user, according to one embodiment of the present invention.

### DETAILED DESCRIPTION OF THE INVENTION

As used herein, “user” refers to a user of the system, device or method, and includes—but is not limited to—a patient, a provider, a third party service provider, such as an insurance company or an emergency call center. Other users are envisioned, such as the owner of personal data stored as an electronic record or account, to which another person—such as a provider, a third party, a financial institution, or any other individual or entity requiring access to the personal information, and to whom access may be granted.

As used herein, “portable electronic device” refers to such devices as smartphones, tablet computers, and client terminals, such as laptops and/or desktop computers. Portable electronic devices are configured with input means, such as a keyboard or touchscreen, memory and a processing unit. Portable electronic devices are configured for communication with one or more servers and/or databases over a network, and may be internet based.

As used herein “authorized user” refers to a user who has previously provided identifying information thereby making them known to the system—for example, one or more identifying attributes collected from the user are input into the system and stored in a database for later use.

Disclosed herein is a system and method for secure account management, comprising a biometric-based verification of an authorized user and management of a protected account. The system and method have broad applications, including secure management of sensitive accounts and/or records (protected account), such as a healthcare record, an insurance account, and/or a financial account. Therefore, the system and method may be configured to provide security and management of protected accounts, ranging from personal healthcare to financial information, and other applications as would be apparent to one skilled in the art.

In one embodiment, a biometric-based verification system, as disclosed herein, comprises a first portable device configured to biometrically verify an authorized user, wherein biometric verification comprises capturing via the portable device at least one of a number of biometric attributes of the authorized user; a first database comprising stored biometric data relating to a number of authorized users; and a second database comprising stored data relating protected personal information; wherein the first portable device is configured to confirm that the at least one biometric attribute of the authorized user corresponds with biometric data stored in the first database associated with the authorized user, and wherein upon verification of the authorized user, the portable device is configured to retrieve protected information from the second database. In another embodiment, the system further comprising means of obtaining a personal identifier via the portable electronic device, wherein the personal identifier is a label or a QR code displayed on the second portable device, and preferably, wherein the label or QR code are displayed on a touch sensitive display of the second portable device when the second portable device detects a predetermined touch on the touch sensitive display, preferably, the predetermined touch is a swipe across the touch sensitive display.

In one embodiment, a biometric-based verification and authorization system, as disclosed herein, verifies a user and authorizes access to a protected account based, in part, on a secure event. In one exemplary embodiment, the system comprises a portable device in wireless communication with one or more of a biometric database, wherein is stored biometric data and criteria relating to a plurality of pre-authorized users, and a client database, wherein is stored protected data, such as personal identifying data, health data and/or financial data means of capturing a biometric attribute of an authorized user from the portable device; means of verifying the captured biometric attribute against the biometric database and upon verification, granting access to the biometrically-verified authorized user to perform an action related to the stored data, wherein the action includes one or more of confirming a healthcare visit or treatment; updating information in a client record; authorizing an action, such as a referral, a diagnostic test, and/or submitting an insurance claim for processing) or a financial transaction (such as an update to an account, a transfer of funds, or other financial request/transaction).

### Biometric-Based Verification of an Authorized User

In one embodiment, a biometric-based verification and authorization system may be configured to use a single biometric or combination of biometrics in order to accommodate different security levels needed for the action which is being validated and/or the environment in which the biometrics are being captured. For example, a system configured to authorize a secure event requiring a high level of security may require the collection and verification of multiple points of biometric data, including but not limited to a capture of an image of the subject's face, capture of a sample of the subject's voice, and/or capture of an iris scan. On the other hand, a secure event requiring a lower level of security may require the collection and verification of a single biometric variable, such as a capture of an image of the subject's face. In one embodiment, biometric data is captured via the portable electronic device using one or more of a device camera, device microphone, or a device touch screen. The collected biometric data is then compared against biometric attributes stored in the biometric database of collected attributes of preauthorized users.

### Secure Events Framework

Biometric-based verification is obtained by the system prior to authorizing an action to be carried out by way of the system, including, but not limited to, an action that requires a reasonable level of user verification in order to secure the confidential and/or sensitive information involved in the action. In one embodiment, the system comprises a secure events framework, wherein the framework comprises attributes, including secure events conditions and one or more verification policies.

In one embodiment, the system is configured with a set of verification policies comprising a hierarchy of elements that must be tested—via the system—prior to authorizing an action. For example, the framework may require a user to “pass” facial and voice verification for the verification policy itself to pass; on the other hand, an action requiring a lower level of security/verification may require simply facial verification. Hence, with the ability to dynamically configure the verifiable elements associated with a policy, the level of security applied to each secure event may be controlled and require different levels of security. Furthermore, by being able to dynamically associate one or more verifiable elements with a policy, the system comprises inherent flexibility to leverage other biometrics (or, in general, other verifiable elements, which may even be non-biometric).

In one embodiment, staggered policies may be dynamically configured within the secure event framework. When staggered policies are established, a verification policy is executed (starting with the first policy configured for the particular action); if it “fails”, then the next configured policy for the relevant secure event is subsequently executed. Staggered policies are executed in sequence until a policy “passes” or all policies have been executed. Staggered policies permit accommodation of varying conditions in the user's environment. For example, in a dark environment, it may be difficult to perform facial matching; or if a person is ill and congested, voice verification may not properly identify the individual; staggered verification policies provide the ability to try multiple verification methods (when appropriate to do so) without sacrificing security.

In one embodiment, secure event framework logic comprises instructions for verifying a secure event and authorizing as user by way of a portable electronic device. On one embodiment, logic is configured as a module of one or more sets of instructions stored on the portable electronic device. In another embodiment, logic is configured as a module or one or more sets of instructions stored on a server in communication with the portable electronic device.

Secure Event Framework Examples

The following Table 1 shows an example of a secure event framework logic employed by a system configured as a healthcare management system. In the example, the secure event conditions are met and a user is verified.

TABLE 1

| Step # | Logic | Details (for this example) |
|---|---|---|
| 1 | Retrieve SE | The business-driven condition configured for the event is “if patient is a |
| | Conditions | member of healthcare plan XYZ”. In this case, the healthcare plan |
| | | administrator has decided all their members must verify themselves before |
| | | performing the event. Hence, the event is considered to be secure for all |
| | | members of healthcare plan XYZ. |
| 2 | SE Conditions | The patient who is trying to execute the event is a member of healthcare |
| | Met? | plan XYZ. Therefore, the SE conditions are met and processing within the |
| | | Secure Event Framework continues. |
| 3 | Retrieve SE | The staggered policies dictated by the stakeholder (i.e., the plan |
| | Policies (may | administrator for healthcare plan XYZ) - and thus configured for the event - |
| | be staggered) | are in the following prioritized order: |
| | | Policy 1: Face and Fingerprint |
| | | Policy 2: Face and Voice |
| | | Policy 3: Face and Iris |
| 4 | Any Untried | Yes. Policy 1 (Face and Fingerprint) has not yet been tried. Start with that |
| | Policy for SE? | policy. |
| 5 | Verify User Via | The app attempts to verify the user in accordance with the policy being |
| | Mobile Device | executed (which is “Policy 1: Face and Fingerprint”). |
| 6 | Policy Fails | User verification FAILS, either because of a failure to match one or more of |
| | OR Timeout | the verifiable elements configured for the policy (face and/or fingerprint |
| | | [Policy 1]) or a timeout during processing (e.g., user did not attempt to |
| | | capture the relevant biometrics in the given timeframe). |
| 7 | Any Untried | Yes. Policy 2 (Face and Voice) has not yet been tried. Continue with that |
| | Policy for SE? | policy. |
| 8 | Verify User Via | The app attempts to verify the user in accordance with the policy being |
| | Mobile Device | executed (which is “Policy 2: Face and Voice”). |
| 9 | Return PASS | User verification PASSES, which means all verifiable elements configured |
| | | for the policy (face and voice [Policy 2]) were properly matched for the |
| | | user. i.e., the user attempting to perform the Secure Event was verified to |
| | | be who they claimed to be - which means PASS is returned to the caller, |
| | | and the user will be able to perform the Secure Event. |

The following Table 2 shows an example of a secure event logic employed by the system; specifically, an example whereby the secure event conditions are met, but a user authentication step fails.

TABLE 2

| Step # | Logic | Details (for this example) |
|---|---|---|
| 1 | Retrieve SE | The business-driven condition configured for the event is “if provider is a |
| | Conditions | practitioner for healthcare organization ABC”. In this case, the healthcare |
| | | organization has decided all their providers must verify themselves before |
| | | performing the event. Hence, the event is considered to be secure for all |
| | | providers of healthcare organization ABC. |
| 2 | SE Conditions | The provider who is trying to execute the event is a practitioner for |
| | Met? | healthcare organization ABC. Therefore, the SE conditions are met and |
| | | processing within the Secure Event Framework continues. |
| 3 | Retrieve SE | The staggered policies dictated by the stakeholder (i.e., healthcare |
| | Policies (may | organization ABC) - and thus configured for the event - are in the following |
| | be staggered) | prioritized order: |
| | | Policy 1: Face |
| | | Policy 2: Fingerprint |
| 4 | Any Untried | Yes. Policy 1 (Face) has not yet been tried. Start with that policy. |
| | Policy for SE? | |
| 5 | Verify User Via | The app attempts to verify the user in accordance with the policy being |
| | Mobile Device | executed (which is “Policy 1: Face”). |
| 6 | Policy Falls | User verification FAILS, either because of a failure to match the verifiable |
| | OR Timeout | element configured for the policy (face [Policy 1]) or a timeout during |
| | | processing (e.g., user did not attempt to capture the relevant biometrics in |
| | | the given timeframe). |
| 7 | Any Untried | Yes. Policy 2 (Fingerprint) has not yet been tried. Continue with that policy. |
| | Policy for SE? | |
| 8 | Verify User Via | The app attempts to verify the user in accordance with the policy being |
| | Mobile Device | executed (which is “Policy 2: Fingerprint”). |
| 9 | Policy Fails | User verification FAILS, either because of a failure to match the verifiable |
| | OR | element configured for the policy (fingerprint [Policy 2]) or a timeout |
| | Timeout | during processing (e.g., user did not attempt to capture the relevant |
| | | biometrics in the given timeframe). |
| 10 | Any Untried | No. All policies configured for this event have been tried. |
| | Policy for SE? | |
| 11 | Return FAIL | User verification FAILS since all policies configured for the event have been |
| | | tried and none have successfully verified the user. |

The following Table 3 shows an example of a Secure Event; specifically, an example whereby the secure event conditions are not met; hence, user verification is not required and thus is not performed.

TABLE 3

| Step # | Logic | Details (for this example) |
|---|---|---|
| 1 | Retrieve SE | The business-driven condition configured for the event is “if (patient being |
| | Conditions | treated is a member of healthcare plan XYZ) AND (provider is a practitioner |
| | | for healthcare organization ABC)”. In this case, the healthcare plan |
| | | administrator (for plan XYZ) and the healthcare organization (ABC) have |
| | | collaborated and decided all providers for the organization must verify |
| | | themselves before performing the event for any patient who is a member |
| | | of the healthcare plan. Hence, the event is considered to be secure for all |
| | | providers of healthcare organization ABC who service patients using |
| | | healthcare plan XYZ. |
| 2 | SE Conditions | The provider who is trying to execute the event is NOT a practitioner for |
| | Met? | healthcare organization ABC and/or the patient being serviced is NOT using |
| | | healthcare plan XYZ. Therefore, the SE conditions are NOT met, the event is |
| | | not considered to be secure under the processing conditions, and event |
| | | processing can continue without the need for user verification. |
| | | Note that this allows the relevant business stakeholders (e.g., a healthcare |
| | | plan administrator and/or a healthcare organization) to dictate the |
| | | conditions/rules under which an event should be considered secure (and |
| | | thus require user verification). |
| 3 | Return PASS | To permit processing of the event to continue, while still utilizing the |
| | | Secure Event Framework whenever the event is encountered (and thus |
| | | supporting consistent event processing for the framework's caller, |
| | | regardless of the context under which the Secure Event is encountered by |
| | | the calling app), the Secure Event Framework returns PASS. |

The following Table 4 shows an example of a secure event logic; specifically, an example whereby the secure event conditions are met and a user is verified. In this particular example, the secure event system framework is configured to provide authentication/verification that the requested user is the owner of an account from which funds are being withdrawn. This example is provided to show the adaptability of the system beyond the healthcare applications detailed herein.

TABLE 4

| Step # | Logic | Details (for this example) |
|---|---|---|
| 1 | Retrieve SE | The business-driven condition configured for the event is “if transaction |
| | Conditions | amount > $X”. In this case, the financial institution handling the transaction |
| | | has decided any user processing amounts greater than $X must verify him/ |
| | | herself before performing the event. Hence, the event is considered to be |
| | | secure for transactions in excess of $X. |
| 2 | SE Conditions | The transaction's amount is more than $X. Therefore, the SE conditions are |
| | Met? | met and processing within the Secure Event Framework continues. |
| 3 | Retrieve SE | The staggered policies dictated by the stakeholder (i.e., the financial |
| | Policies (may | institution handling the transaction) - and thus configured for the event - |
| | be staggered) | are in the following prioritized order: |
| | | Policy 1: Face and Fingerprint and Voice |
| | | Policy 2: Face and Fingerprint and Iris |
| | | Policy 3: Face and Fingerprint and PIN and Security Question |
| 4 | Any Untried | Yes. Policy 1 (Face and Fingerprint and Voice) has not yet been tried. Start |
| | Policy for SE? | with that policy. |
| 5 | Verify User Via | The app attempts to verify the user in accordance with the policy being |
| | Mobile Device | executed (which is “Policy 1: Face and Fingerprint and Voice”). |
| 6 | Return PASS | User verification PASSES, which means all verifiable elements configured |
| | | for the policy (face and fingerprint and voice [Policy 1]) were properly |
| | | matched for the user. i.e., the user attempting to perform the Secure Event |
| | | was verified to be who they claimed to be - which means PASS is returned |
| | | to the caller, and the user will be able to perform the Secure Event. |

### Exemplary Electronic Healthcare Management System

In one embodiment, a biometric-based verification and authorization system, as disclosed herein, verifies a user and authorizes a user action, the system comprising a portable device in wireless communication with one or more of a biometric database, wherein is stored biometric data and criteria relating to a plurality of pre-authorized users, and a protected data database, wherein is stored data related to a patient, such as an electronic patient healthcare record; means of capturing a biometric attribute of an authorized user from the portable device; means of verifying the captured biometric attribute against the biometric database and upon verification, granting access to the biometrically-verified authorized user to the patient record; and means of performing an action related to the client record, wherein the action may be one of confirming an event, such as a healthcare visit or treatment; updating information in the client record; authorizing an action, such as a referral, a diagnostic test, and/or submitting a claim for processing.

In one embodiment, a system comprises a mobile application stored on a machine-readable storage medium on a portable device. In one embodiment, the mobile application executes a method for biometric-based management of a scheduled visit between a patient and an authorized provider comprising: capturing one or more of a biometric attribute of a user seeking access to the system via the portable device; comparing the captured biometric attribute against a biometric database in order to confirm a match to pre-collected biometric data to authorized users; verifying based on the one or more of a biometric criteria, an authorized user, wherein the authorized user is one of a pre-authorized patient or a pre-authorized provider; and permitting the biometrically-verified authorized user access to perform one or more of the following actions on the system: (a) record of a scheduled visit comprising a patient name, a provider name, and one or more visit details, such as date, time and location; (b) accessing one or more of a patient health record of the authorized patient, (c) managing services or treatments provided to a patient, and (d) updating a patient health record, in any combination thereof using input means on the portable device.

In one embodiment, biometric verification is performed for each of a patient and a healthcare provider, in order to ensure that the proper patient and provider are present (i.e., the patient having made the appointment and the provider assigned to the appointment). In another embodiment, the system is configured such that GPS validation wherein GPS coordinates of the portable electronic device are captured and stored in the database is also performed to ensure that the proper individuals are present at the intended appointment location (e.g., provider's office; or, for home healthcare visits, the patient's place of residence). In another embodiment, an indication of each individual's validation status is displayed to the patient and the provider. In another embodiment, the patient and/or provider “check in” via the electronic device by initiating the mobile application and selecting from a menu of options, such as “doctor visit check in”, or “prescription refill”—as the case may be—in order for the system to create a log and/or time stamp to store associated with the patient record of the event.

Turning now to the figures, which show an overview of various embodiments of the present invention and exemplary implementations. The figures are intended to be illustrative and not exhaustive.

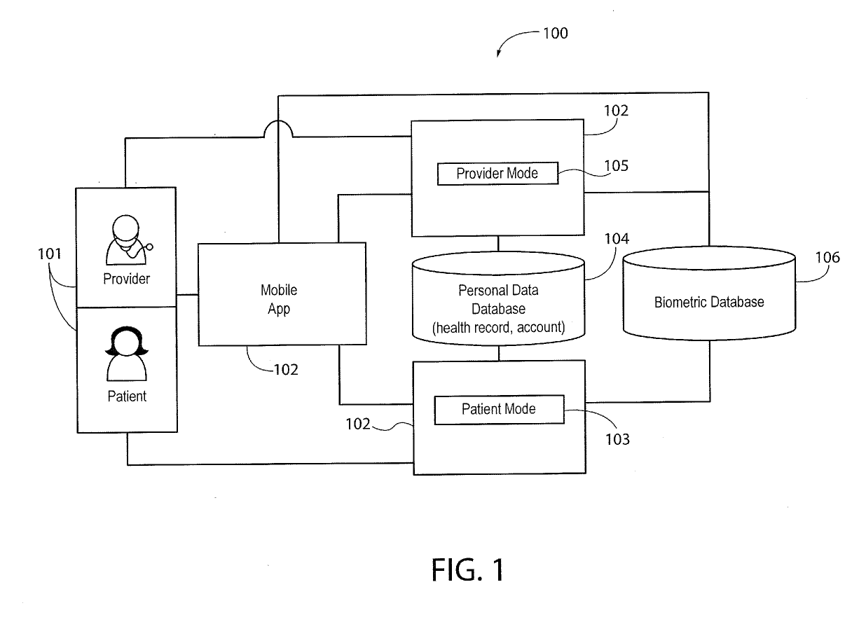

FIG. 1 shows an overview of a system 100 for accessing, managing and updating a patient healthcare record according to one embodiment of the present invention. In one embodiment, system 100 comprises a portable device 102 whereon instructions are stored for executing a secure event framework for biometrically verifying an authorized user 101—in this example, authorized user may be a healthcare provide or a patient. Other components of the system include a first portable device 102 configured with a patient mode 103; a second portable device (provider device) configured with a provider mode 105; a database 104 comprising protected data; a biometric database 106. The system further comprises means of capturing biometric attributes of an authorized user to be verified (not shown); and means of biometrically verifying an authorized user to the system via the secure event framework (not shown).

In one particular embodiment, the systems are configured for different functionality, depending on the mode. In one example, a patient mode is configured as a web application or a mobile application on a device. In one embodiment, a user completes an electronic medical history. The system compiles a patient health record based on the inputted data and stores the patient information (history and health record collectively) in a patient database (protected database). In another embodiment, a provider mode is configured as a web application or mobile application on a portable device.

In one embodiment, a provider creates an authorized user profile. Biometric data from, and unique to, the authorized provider is collected via a portable electronic device (camera, microphone or touch screen) and the biometric data is assigned to a provider profile and stored on a biometric database. The provider account is registered and stored in a biometric database under a “pre-authorized” provider profile. Thus, at the time of a patient-doctor visit, for example, a user operating a device configured as a patient mode can record a visit with a doctor, or record a prescription fulfillment, and incorporate the events as part of their mobile health record. Likewise, a provider operating a device configured as a provider mode, can retrieve a patient record and confirm they say the patient on the time/date indicated with the timestamp, or confirm that the patient's prescriptions are up to date, or confirm other actions such as an order for diagnostic tests—or one or more various other actions that may be performed by a provider for a patient for whom the provider has verified access to the patient account.

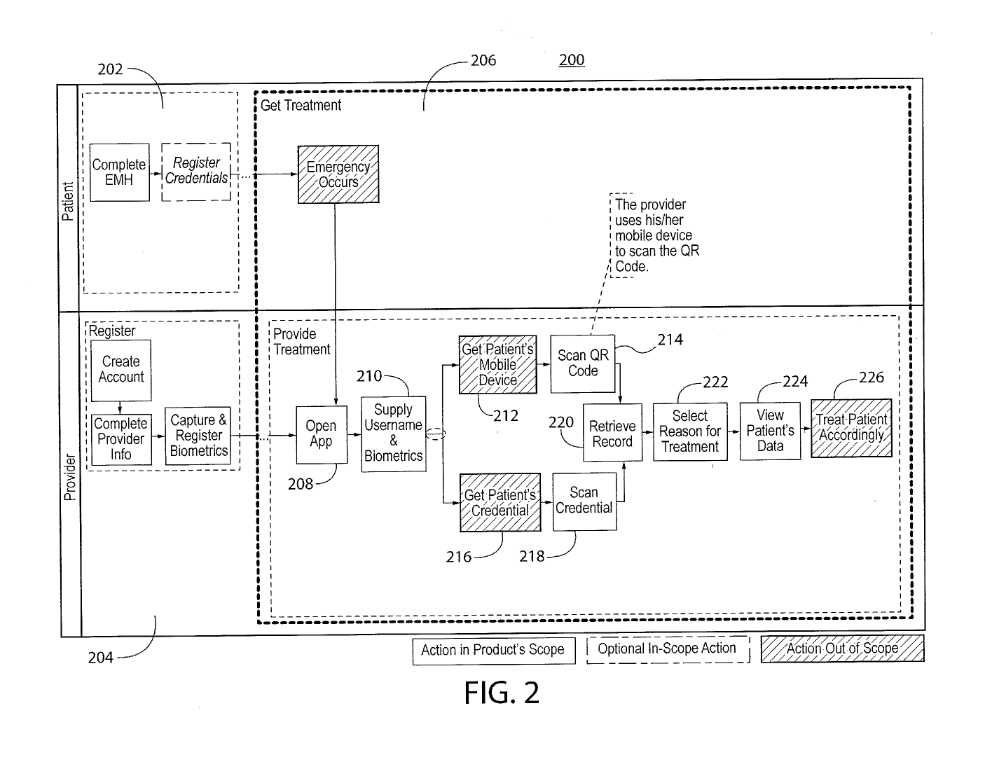

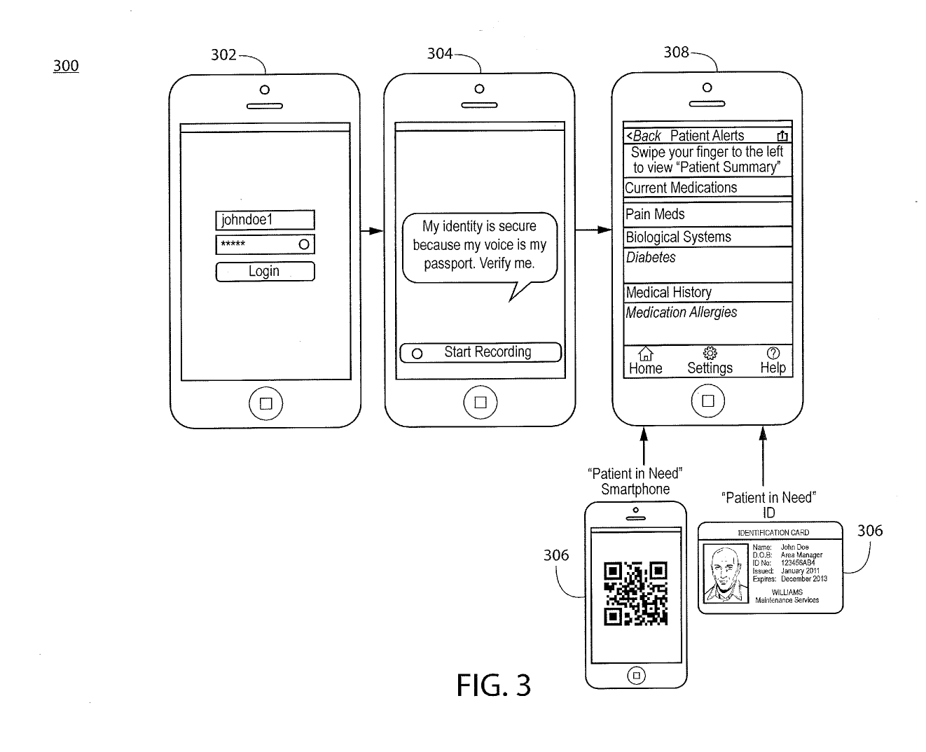

FIG. 2 shows an overview of a system 200 for biometric verification and authentication of a patient provider transaction according to one embodiment of the invention. A patient registration process 202 is carried out in which a patient, via a portable electronic device, configured with a patient mode, creates a secure account, completes an electronic medical history (EEMH), registers credentials, and downloads a mobile application to a portable electronic device (such as smartphone or tablet).

In one embodiment, the account is created on a portable electronic device, although may also be created using a patient mode via a web application that collects identifying information and other data over a web interface. A provider registration process 204 is carried out in which a provider, via a portable electronic device, configured with a provider mode, creates a provider account, completes provider information to be stored in a database, downloads a mobile application to a portable electronic device, and captures and registers biometrics of the provider, which are in turn stored in the biometrics database.

Upon a treatment request (shown in the figure as “Emergency Occurs”), a process for biometric verification of a provider is carried out to initiate a treatment process 206. Treatment process 206 is initiated when a provider launches the provider mode comprising the mobile application for biometric verification and emergency treatment protocol at step 208. The provider inputs, via the electronic device, user account information including biometric data at step 210 for authentication, upon authenticating the provider, the provider has an option to either obtain the patients mobile device at step 212 and scan the patients QR code using the scanner on the provider device at step 214, or obtain patient credentials using the providers mobile device at step 216 by scanning a credential (wherein credential is identifying information) of the patient at step 218. In either instance, a patient record will be retrieved from a protected database at step 220, and a provider will select a reason for treatment on the mobile device from a list of options presented, at step 222, the provider may then view the patient's data upon retrieval of the record from the database, which are displayed on the mobile device, at step 224, prior to treating the patient at step 226.

In another embodiment, the system may also be configured for an update to a health record using a portable healthcare management system on a portable device. The system comprises a portable device configured to receive input from an authorized user as confirmation of an event occurrence, such as a health visit, at a time of check-in and/or at a time of check-out of the health visit or for a prescription fulfillment at a pharmacy or hospital. The portable device is configured so that the system captures one or more parameters associated with the visit. In one embodiment, the system is configured to collect parameters such as date, time, and GPS location, from the portable device of the authorized user at a time of a health visit, and records one or more of the parameters in association with a patient health care record.

In one embodiment, the collected information is stored as a timestamp confirming that an event occurred as part of the patient record in the database. The collected information is collected and stored as part of the patient data record in the protected database and made available for later retrieval by an authorized user, such as the patient or provider (or other authorized user such as insurance carrier).

In another embodiment, a process for biometric verification and authentication is embodied as a mobile application 300 running on a portable electronic device. For example, an authorized user logs-in to the mobile application via their device at step 302, biometrics of the authorized user are collected and verified at step 304. For example, a voice sample may be collected utilizing the microphone of the device. Once the authorized user has been verified, access to a patient's medical record is allowed at step 306. The authorized user can then access a healthcare record via the device, and retrieve information related to the patient, such as current medications, medical conditions, etc., at step 310. When a request is made by the verified user on the device, a request is sent from the device to the patient database (protected account) and the record associated with the request is sent from the database to the device.

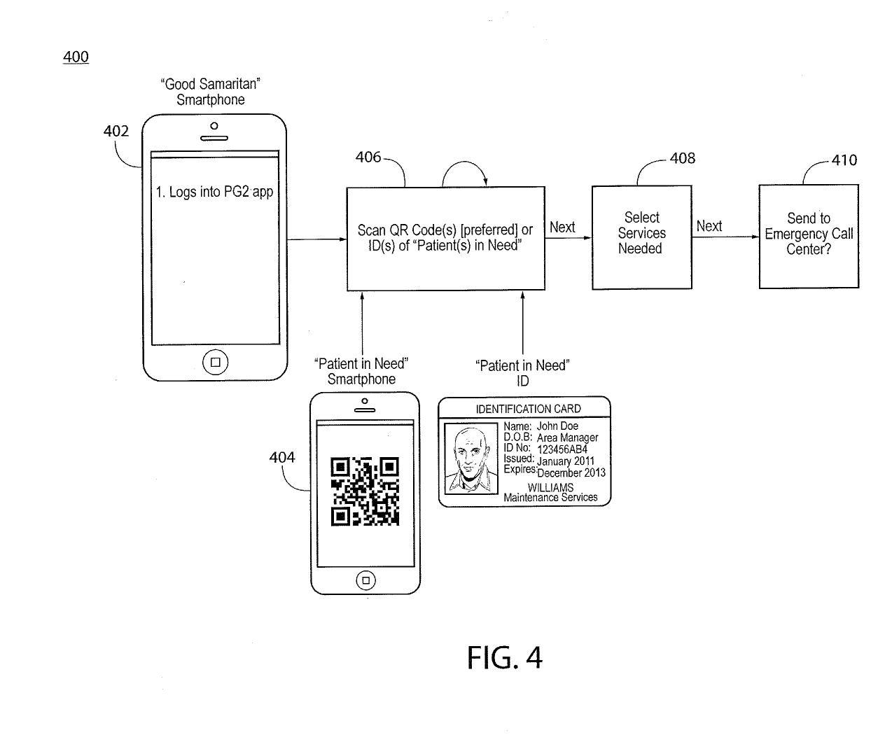

FIG. 4 shows an overview of a process for accessing a patient healthcare record—under an emergency situation—using a first device (referred to as a “Good Samaritan Device”) configured with a mobile application for accessing a healthcare record, and a second device (referred to as “Patient in Need Device”) configured with the mobile application for accessing a healthcare record. Using a first device 402, the scanner camera of the first device is used to scan a QR code of the second device 404, at step 406, to retrieve treatment options that are presented on the display on the portable device. Services needed (such as: ambulance, fire, police) are presented on the device at step 408, and an action is requested via the first device at step 410. At the time the action is requested, the mobile application will perform the steps of: searching for data associated with the patient in an application database; send one or identifying information to an emergency call center, if contacted, such as: sender's device number (cell phone number), GPS location, services needed, and any patient data. This allows for valuable information to be sent and obtained by the emergency responders in advance of care but not at the expense of privacy or security of the patient-in-need.

In another embodiment the system may be configured as a mobile patient emergency alert system comprising a first device configured as a “person-in-need” device running a patient mode; and a second device configured as a Good Samaritan (GS) device running an application on the device as a Good Samaritan mode. At step 1, the GS device is utilized to retrieve embedded patient identifying information from a bar code, or other readable storage medium, on the patient-in-need device, or by scanning an ID bar code from a patient ID (such as a driver's license) using the camera of the GS device. At step 2 the GS mode provides the user a menu comprising a list of options from which to select in order to provide aid. At step 3 an option is selected via input means on the GS device, for example—the selecting a command (such as Call 911; Get Help: or Emergency, or other prompt) in response to the emergency situation. At step 4a, the system performs a search of one or more databases containing records of the patient in need, the system collects additional information, including but not limited to: patient identifying information, a device contact number, location information such as GPS coordinates; the system then transmits the information about the patient and the services requested to a third party service provider, such as an ambulance service. At step 4b, a confirmation message is generated and displayed on the GS device in response to the request, thereby confirming that the requested service has been processed and the service provider has been notified.

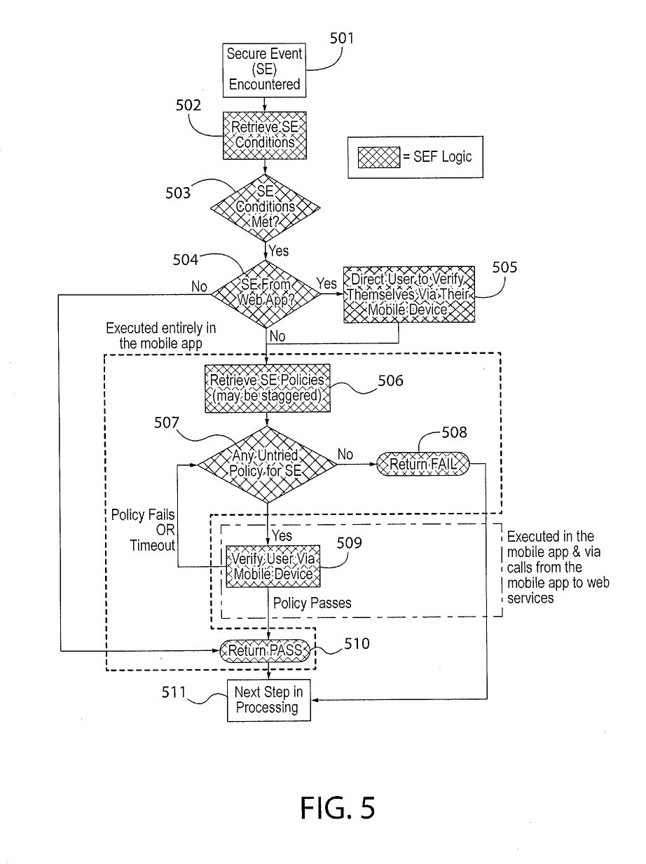

FIG. 5 shows an overview of a secure event verification and authentication process 500, whereby a secure event (SE) is encountered at step 501. Secure event conditions are retrieved from the server, via a web service call. The conditions are in the database stored as configurable parameters for the Secure Event, and the web service retrieves them from the database at step 502. SE logic then queries if the conditions correspond to the conditions of a secure event, at step 503, and if the answer is NO the event can proceed without any user verification. If secure event conditions are met upon processing at step 504, then the user is directed to verify themselves via their mobile device at step 505. Secure event policies are then retrieved from the database at step 506, and all policies for secure events are retrieved and applied to the verification at step 507. If there are no additional polices to retrieve for secure events, then the system will return a failure or message indicating that a step may not be performed. The authenticating user then verifies their identity via the mobile device at step 509 using a biometric-based verification. If the biometric verification is processed and verifiable elements are confirmed, then the user has been verified at step 510, the system will advance to the next step in processing the request of the user at step 511.

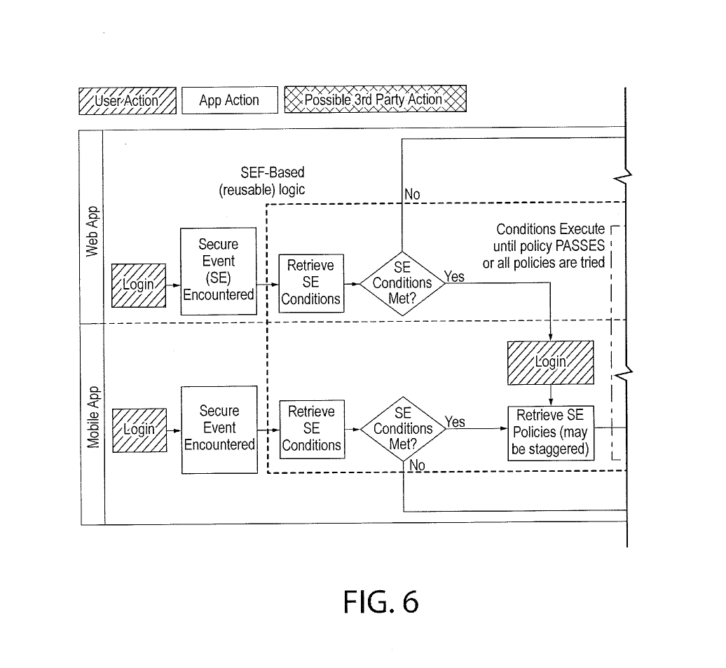

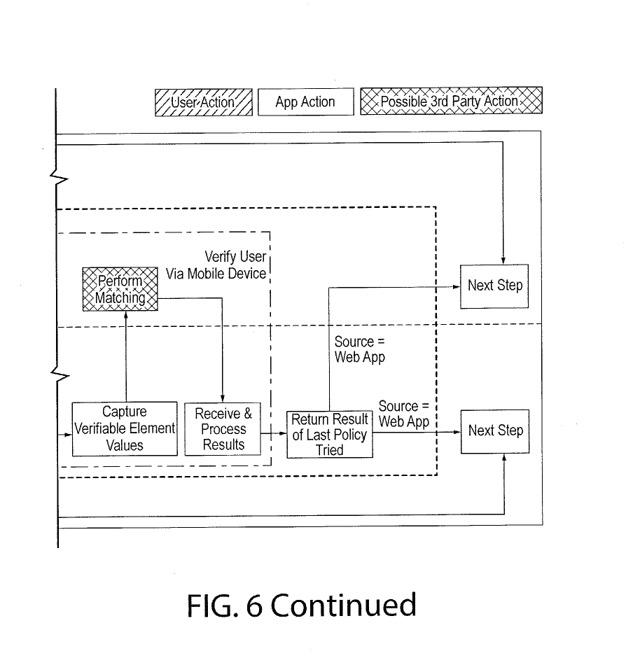

FIG. 6 shows an expanded view of the secure event framework shown in FIG. 5, specifically the logic carried out via a web application and mobile application.

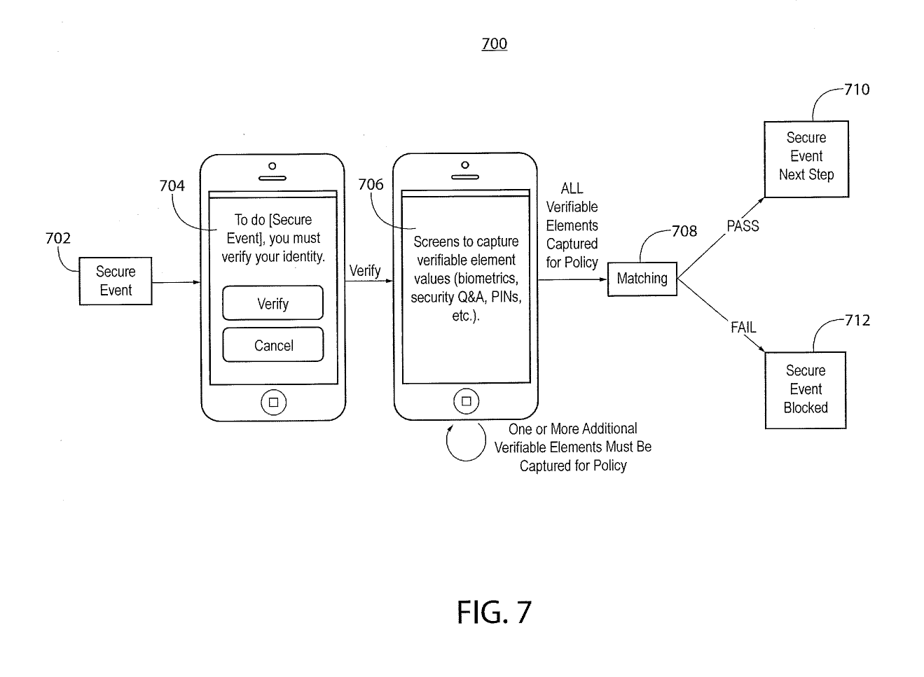

FIG. 7 shows an overview of an exemplary embodiment of the invention wherein a portable electronic device is configured with a secure event framework 700. A secure event 702 is encountered requiring verification of an authorized user prior to granting access to a protected account/data. For example, a user will be prompted on a screen of the device that to carry out the activity, verification of identity is required (step 704). The user is then presented with one or more verification requests, such as a biometric verification request, a personal identifier request, such as a PIN or answer to security question (step 706). Once the necessary requirements are captured via one or more input means of the device (such as a scanner unit, a camera, a microphone, a touchpad, a keypad, or the like), then collected attributes are sent to a database for matching and verification against collected data of pre-authorized users (step 708), if the matching step results in a pass, then a next verification step (step 710) will be initiated (such as a second verification step), alternatively, if the matching step results in a fail, then the secure event is blocked (step 712).

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other components, integers or steps. Throughout this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The reader's attention is directed to all papers and documents which are filed concurrently with or previous to this specification in connection with this application.

1. A biometric-based verification system comprising:
a first portable device configured to biometrically verify an authorized user, wherein biometric verification comprises capturing via the portable device at least one of a number of biometric attributes of the authorized user;
a first database comprising stored biometric data relating to a number of authorized users; and
a second database comprising stored data relating protected personal information;
wherein the first portable device is configured to confirm that the at least one biometric attribute of the authorized user corresponds with biometric data stored in the first database associated with the authorized user, and wherein upon verification of the authorized user, the portable device is configured to retrieve protected information from the second database.

2. A system according to claim 1, wherein the first database and the second database are stored on at least one remote server, and wherein the first portable device is provided with a communication unit for communicating with the remote server to access the first and/or the second database.

3. A system according to claim 1, wherein the first database is stored on the portable device.

4. A system according to claim 1, wherein the second database is stored on the portable device.

5. A system according to claim 1, wherein the first portable device is configured to perform at least one action related to protected information stored in the second database, selected from: (a) accessing one or more of a record compiled from personal information, (b) managing services related to the personal record, and (c) updating the personal information contained in a record, in any combination thereof using the first portable device.

6. A system according to claim 1, wherein the first database and/or the second database comprise stored data including personal identifying information, selected from: government-issued identifying information such as a social security number (SSN), a passport number, a driver's license number, for a particular authorized user, wherein the authorized user has provided information related to identity and/or health history for encrypted storage in one or more of the first database or second database.

7. A system according to claim 1, wherein the first database comprises at least one of: a biometric attribute or government-issued identifying information for an authorized user, wherein the authorized user has provided at least one biometric attribute selected from the group: images, fingerprint scans, or voice data, for encrypted storage in the first database.

8. A system according to claim 1, further comprising a second portable device configured to provide a personal identifier to the first portable device, wherein the personal identifier provides identification information of a patient and provides authorization to retrieve the a healthcare record associated with the protected information stored in the second database.

9. A system according to claim 8, wherein the first portable device is configured to scan a label displayed on the second portable device, and wherein the label provides the personal identifier, allowing the first portable device to retrieve a personal record from the second database.

10. A system according to claim 9, wherein the personal identifier is a label or a QR code displayed on the second portable device, and preferably, wherein the label or QR code are displayed on a touch sensitive display of the second portable device when the second portable device detects a predetermined touch on the touch sensitive display, preferably, the predetermined touch is a swipe across the touch sensitive display.

11. A system according to claim 1, wherein the first portable device is configured to access a patient emergency alert system, and wherein a patient is identified by the first portable device by scanning a patient identifier, wherein scanning is performed using a scanner unit of the first portable device; the first portable device being configured to display options within the patient emergency alert system and upon selection of an option, the first portable device is configured to transmit patient identifying information and a GPS coordinate or location of the first portable device from the first portable device to an emergency response entity.

12. A portable device comprising:
a scanner unit configured to capture at least one biometric attribute of an authorized user;
a control unit configured to biometrically verify an authorized user wherein the control unit controls a communication unit configured to communicate with a first database and confirm that the at least one biometric attribute of the authorized user corresponds with biometric data stored in the first database associated with the authorized user, and wherein upon verification of the authorized user, the portable device is configured to retrieve authentication from a second database wherein the second database comprises stored data relating to an authentication for a secure event.

13. The device of claim 12, wherein the biometric attribute is one or more of a fingerprint, all or a portion of a facial image, a voice recording or sampling, and/or an iris scan.

14. A non-transitory computer-readable medium having recorded thereon a program that causes a portable device to execute a method for updating a patient medical record to record the occurrence of an event, the method comprising: capturing via a portable electronic device at least one of a number of biometric attributes of an authorized user;
communicating with a first database to verify whether the first captured biometric attribute corresponds to a pre-captured biometric attribute of the authorized user, wherein the first database comprises data corresponding to biometric attributes of the authorized user, and wherein the first database is stored on at least one remote server;
retrieving at least a portion of a patient's healthcare record upon verification of the authorized user, wherein the patient's healthcare record is stored in a second database, and the second database is stored on at least one remote server;
collecting information from the portable device comprising one or more of time, date, GPS coordinates or other location identifying information, and creating a timestamp record as an event record; and
updating the at least a portion of a patient's healthcare record to include the event record confirming the occurrence of the event.

15. The method of claim 14, wherein the event record is a confirmation of one or more of the following occurred: a health visit with an authorized provider; a prescription order fulfillment; or a home health visit with an authorized provider, and/or an insurance claim submission related to a healthcare event.
